(19) United States
(12) Patent Application Publication
(10) Pub. No.: US 2018/0137666 A1
(43) Pub. Date: May 17, 2018

(54) Method and system to record, store, transmit and play free hand drawings and handwritings like a movie or animation showing pen movements

(71) Applicant: Daniel Markus Steiner, Basel (CH)

(72) Inventor: Daniel Markus Steiner, Basel (CH)

(21) Appl. No.: 15/352,409

(22) Filed: Nov. 15, 2016

(51) Int. Cl. G06T 13/80; G06F 3/16; G06T 11/20; G06F 3/0488; G06T 11/60

(52) U.S. Cl. CPC G06T 13/80; G06F 3/16; G06T 11/60; G06F 3/04883; G06T 11/203

(57) ABSTRACT

Method and system for software to record, store, transmit and play a free hand drawing or hand writing like a movie or animation are disclosed. The system contains a computer paint program with a software recorder component. The software recorder component continually captures time and computer pointing device movement such as mouse or finger on a touch screen. The paint program saves this computer pointing device movement data to a file, instead of an image or video file. Further the system comprises of a software player component which plays back and animates the free hand drawing or hand writing like a movie or animation based on the recorded data. The software player component further comprises of adding a pen, pencil or finger to the animation play. The animation shows how the author moved, lifted and lowered the pen over time and the hand drawing or hand writing comes into existence.

### PRIORITY CLAIM

The present application claims priority from U.S. provisional patent application No. 62/256,231 filed on Nov. 17, 2015 and entitled “Method and system to record, store, transmit and play free hand drawings and handwritings like a movie or animation”.

### FIELD OF THE INVENTION

The present invention relates generally to electronic arts. More specifically, the present invention relates to media content production, storing, transferring and playing animations.

### BACKGROUND

Take a blank paper and draw for example a flower with a pen. Done without guiding instruments, measurement, or other aids it's considered to be a free hand drawing. Or write some text with chalk on a blackboard. It's a handwriting. Such hand drawings and writings have unique characteristics and are different from photographs and illustrations.

Hand drawings and writings can also be created with a simple paint program on a computer or smartphone connected to a computer pointing device such as a mouse or touchscreen. Normally such a drawing or writing is saved by the user or author as static image and then sent or distributed over the internet to other people.

However, a static image shows only the end result of a free hand drawing or handwriting. How the author moved, lifted and lowered the pen over time is not seen. This information is lost.

The author could video record his computer screen while he draws or writes with the computer pointing device such as a mouse or finger on a touchscreen and then distribute the video file. Or the user could take a white board animation software which generates a video file as output. Or any other animation software which generates an animation file containing a sequence of images. Creating a video file to send a short message or drawing is complicated and an overkill. The disclosed invention offers a better way and alternative to common video and animation files. It works for free hand drawings and handwritings with pen animation as described above.

### BRIEF SUMMARY OF THE INVENTION

Methods, systems, and computer program products for recording, storing, transmitting, playing and rendering of free hand drawings and handwritings with pen animation are disclosed herein.

According to an example embodiment, a computer-implemented method is disclosed. Due to the unique characteristics of free hand drawings and handwritings it is already enough to continually record the position of the pen and the current time while the author draws or writes content. This is accomplished in form of a computer paint program which includes a software recorder component.

The recorder component inside the paint program records the coordinates and height of the computer pointing device such as a mouse or human finger on a touch screen. The current time or time stamp is also recorded. Height means the computer mouse button is up or down. For touchscreen devices height means the finger either touches the screen or is up in the air. Only this information is stored into a file or database with the purpose of redrawing the image later on again and adding a pen animation. This is different from storing and distributing an image or a video file.

Another part of the invention is the software player component which plays back the free hand drawing or handwriting. With the recorded computer pointing device movement data and the time stamp data previously captured by the software recorder component, the content can be redrawn like a movie or an animation. The play shows how the author moves, lifts and lowers the pen over time and the drawing or writing comes into existence.

The necessary information stored is much smaller than that of video recordings. The disclosed invention offers a unique way of writing, sending, receiving and playing personal messages and drawings like self-drawn emoticons with computers and smart phones. It further comprises of adding a pen, pencil or human finger animation to the play.

In another aspect, the method provides the possibility to add the software player component to a web page as overlay and be used as advertisement banner in order to draw attention and generate revenue by clicking the animation in order to come to another web page.

In yet another aspect, the invention provides the option to increase or decrease the pen's width during recording, during playing or at the end of a recording.

In a further aspect, the invention provides possibility to the user to play the drawing faster or slower.

In another aspect, the method comprises a further step of replaying the animation before the user saves and sends the free hand message or free hand text to friends.

Another aspect of this invention is to enrich the drawing animation with sound effects. The file with the data from the software recorder component contains the information when the author lifted and lowered the pen. These actions can be accompanied with sound effects.

In another aspect, the method provides the possibility to add shadow to the lines as an additional animation feature to highlight the pen's position.

### BRIEF SUMMARY OF THE DRAWINGS

FIG. 1 shows one example of an implementation of a computer paint program into a web page which continually records computer mouse position and time while the user free hand draws or handwrites.

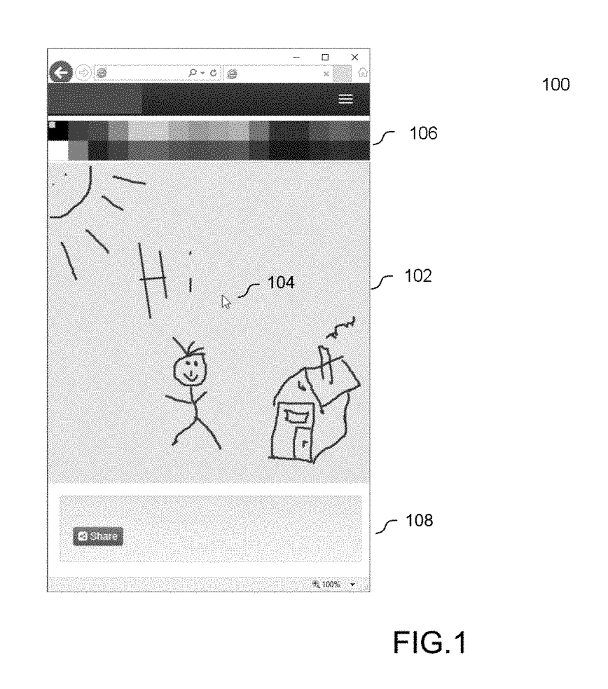

FIG. 2 contains a flow chart diagram illustrating the program workflow of the software recorder component in the paint program.

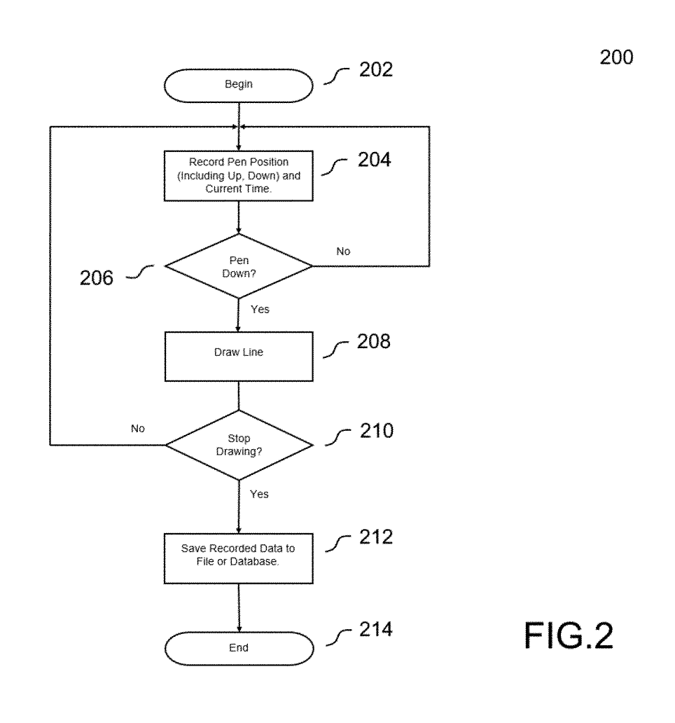

FIG. 3 shows an example of the stored data by the software recorder component. It contains the computer pointing device movement data such as a mouse or human finger movement on a touchscreen.

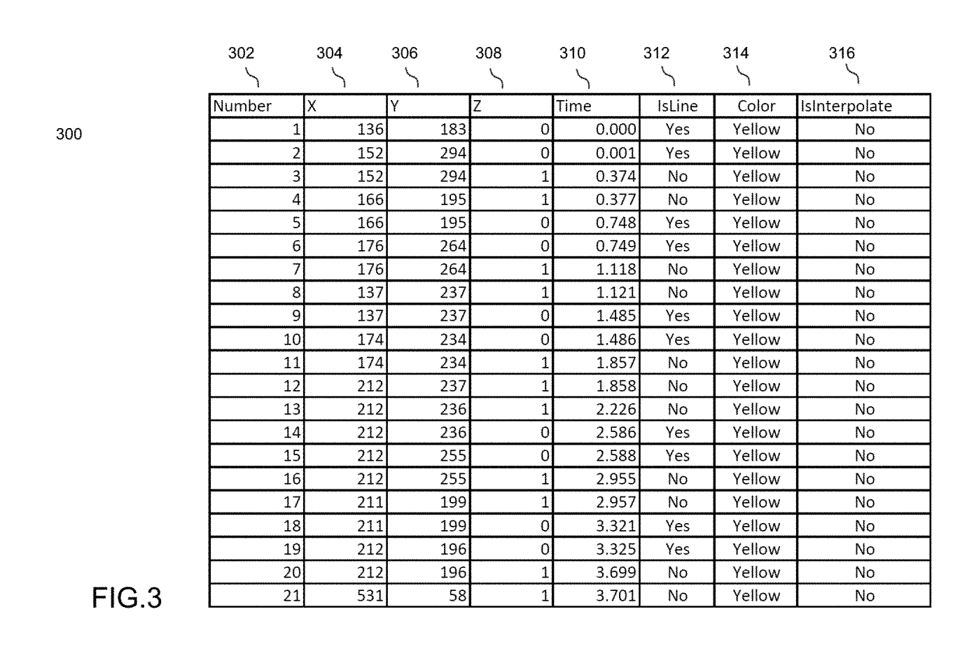

FIG. 4 shows one example of an implementation of the software player component into a web page to play back the recorded pen movement data like a movie or animation. It shows how the pen moves and the free hand drawing or hand writing comes into existence.

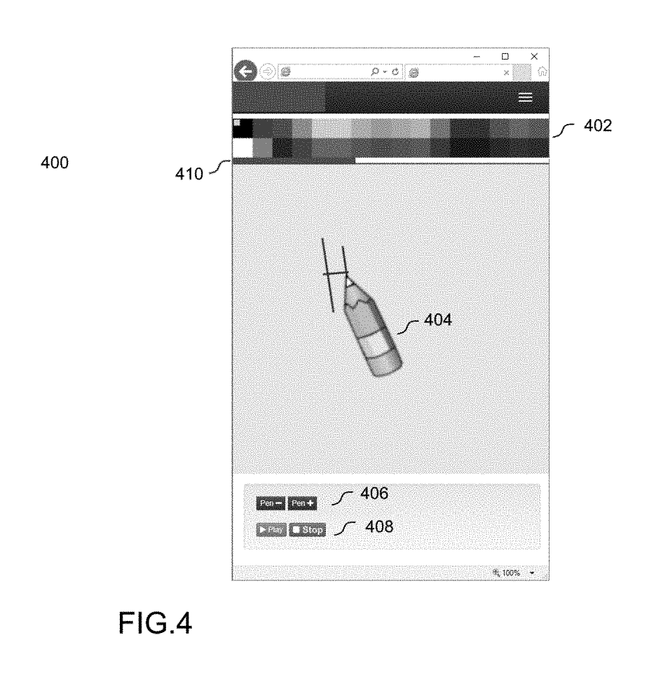

FIG. 5 contains a flow chart diagram illustrating the program workflow of the software player component.

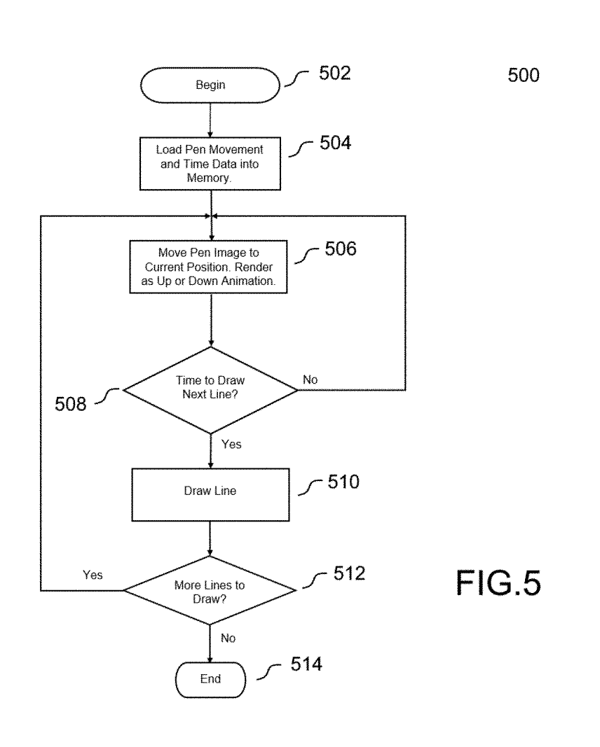

FIG. 6 shows an example of the software player component used for banner advertisement on a web page to draw attention and generate revenue.

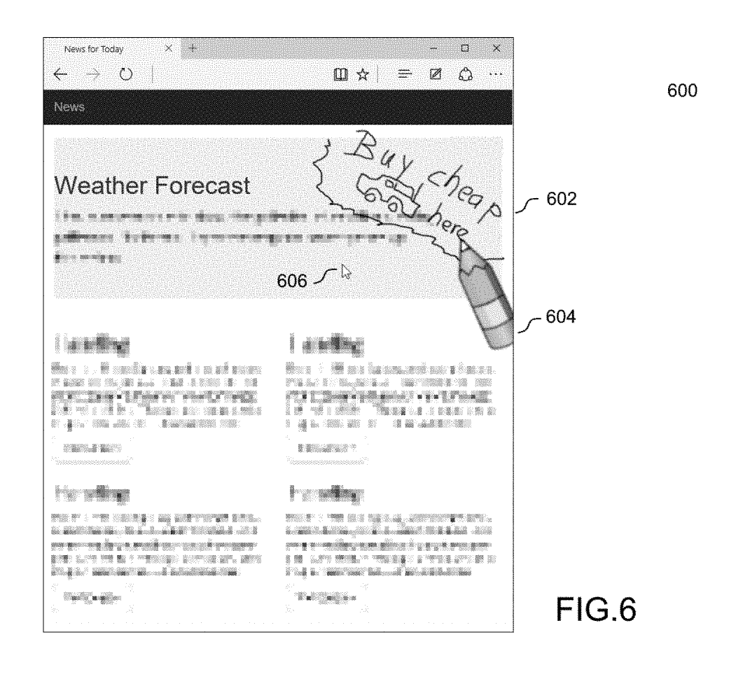

FIG. 7 shows one example of the pen, pencil or human finger animation. Either up in the air or touching the paper and drawing. The pen's position up or down is highlighted with a shadow.

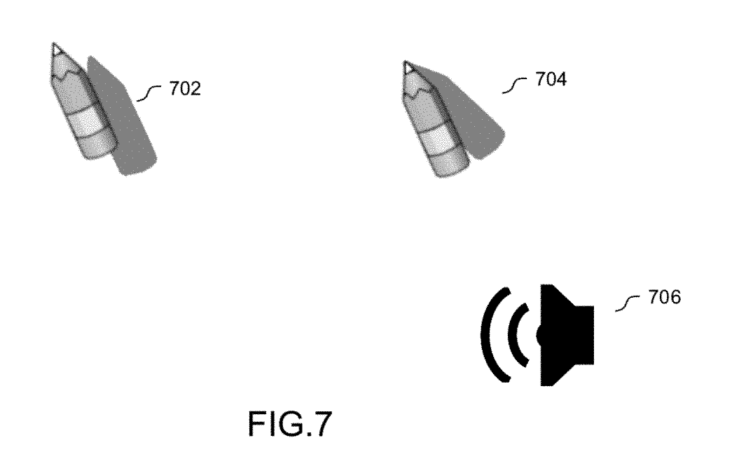

### DETAILED DESCRIPTION OF THE INVENTION

While the present invention is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility. Further, when a particular feature, structure, or characteristic is described in connection with an embodiment, it is submitted that it is within the knowledge of one skilled in the relevant art to affect such feature, structure, or characteristic in connection with other embodiments whether or not explicitly described.

It would also be apparent to one of skill in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Disclosed herein is a system for recording, storing, transmitting playing and rendering free hand drawings and/or handwritings. Paint programs for computers, smart phones and tablets use computer pointing devices such as a mouse or a touchscreen to capture a user's input. Hand drawings and handwritings are rendered to the screen.

The disclosed invention offers a method and computer paint program 100 which continually records the position and time of the pen 104 while the user free hand draws or handwrites. This is different from common computer paint programs. Position means X and Y coordinates and Z coordinate of the pen. The pen is also a computer pointing device like a mouse or a touchscreen. For computer mouse devices Z coordinate means typically button up or button down. For touchscreens, it is typically the exercised pressure of a human finger on the screen.

In terms of recording and painting workflow 200 this means the recorder starts 202 for a new drawing. While the user free hand draws, or handwrites, the recorder component captures the current position of the pen and the current time 204. A pen is also a stylus. If the pen is up in the air 206 meaning for example the computer mouse cursor moves around without drawing, the recorder component keeps recording position and time. If the pen is down 206 meaning the computer mouse button is pressed or the human finger touches the touchscreen, then a line is drawn 208 to the screen where the pointing device points to. If the user decides to stop the recording 210, the captured data is stored as a file or data stream or written into a database 212. The recording is finished 214. The data can now be published and shared with friends 108.

The disclosed method and computer program stores the recorded information sequentially 302 in a file or database 300. The example is provided as a table data structure. One entry of such an information contains X position of the pointing device 304, Y position of the pointing device 306, Z position of the pointing device 308 and the current time 310. Such an entry may also include attributes like the color 314 and width of the currently used pen.

The user is not always drawing a line when touching the screen or when clicking the computer mouse button. For example, when the user selects a different color 106 no line and no point is drawn. But later in the animation play, we also want to see how the user moved the computer mouse to the color field and clicked it. This distinction is stored in field 312.

The stored information and output data 300 of the computer paint program recorder, is completely different from image, photograph or movie files. For small drawings and handwritings, the size of the file is much smaller than a movie file. Therefore, it cannot be played with any common movie player or picture viewer.

One example illustrates the output of the recorder component and shows data 300 recorded of a handwriting over a time period of 3.701 seconds.

The disclosed method and computer program offers also a software player component 400 which can render and animate the act of drawing or handwriting back to a screen like a movie. How the author moved, lifted and lowered the pen 404 over time is clearly seen in the animation. Because the time information is stored in the file 300, the process of redrawing can be slowed down to the pace of the authors moving of the pen. The player can be controlled with play, pause and stop buttons 408 and holds like any other movie player a progress bar 410 indicating the current play time. Additionally, transformations can be applied like increasing or decreasing pen width 406 while playing.

In terms of software player component workflow this means the user clicks the play button 408 and the animation starts 502. First the pen movement data is loaded 504. The pen image is moved 506 on the screen to the current play position.

The process 506 renders a different image or animation of the pen, depending whether the pen is at current play time, up in the air 702, or touches the paper 704 emphasized by the pen's shadow. Another embodiment of 700 can be a human finger instead of a pen. In yet another embodiment pen 700 movement is accompanied with sound effect 706 based on the previously recorded computer mouse movement data 308 when the pen is lowered.

If enough time elapsed till now 508, the next line is drawn 510. Otherwise the process keeps updating current pen animation 506. If all data 300 has been processed 512, the animation is finished and the progress bar 410 of the player reached 100 percent and stops 514.

There is a difference between computer mouse pointing and touchscreen devices. Computer mouse pointing devices always transmit the coordinates to the computer. No matter whether the button is clicked down or not. Most touchscreens however only transmit the coordinates to the computer while the human finger is down on the screen. When the finger is lifted up and moved to another position no coordinates are transmitted. How the user moved his finger in the air while not touching the screen this information is lost.

The disclosed method and computer program compensates this loss by applying linear interpolation or Bezier curves and inserts such data records into the data table. Additional data points are added. 300. Such entries are marked with a flag 316. Any other algorithm which estimates the lost information can be applied.

The disclosed computer program also allows to configure and change the image of the moving pen 404. Instead of a pen a finger could be shown.

The disclosed invention also offers the possibility to use the software player component on a web page 600 for banner advertisement. Instead of a video file or animation file which displays a sequence of images, the data described in 300 is processed by the software player according to the flowchart in 500. The pen 604 writes over time a message or paints a free hand drawing. In the example, it is shown with transparent background and as overlay. The user can click with the computer mouse 606 the advertisement like on any other banner advertisement on the internet.

1. Method and system for software to record, store, transmit and play free hand drawing or hand writing like a movie or animation comprising of:
(a) a software recorder component, wherein the component continually records time and computer pointing device movement.
(b) distributing recorded data from the software recorder component over a network.
(c) a software player component playing back the transmitted data from the software recording component, meaning it plays back the data like a movie or animation, showing how the freehand drawing or freehand writing comes into existence over time.
(d) a pen, pencil or finger animation added by the software player component showing how the author moved, lifted and lowered the pen over time.

2. The method of claim 1 wherein said the software player component adds sound effects based on the data provided by the software recorder component such as lowering the pen.

3. The method of claim 1 wherein said the software player component is added to a web page and is rendering the animation as overlay to draw attention, meaning the animation is used as advertisement banner and can be clicked to get to another web site.

4. The method of claim 1 wherein said the recorded data from the software recorder component is enriched with interpolating data points for missing data when touch screen is used, meaning no data can be captured while author moves finger in the air to the next point, such missing data is interpolated.

5. The method of claim 1 wherein said the recorder component allows to change the color of the pen.
